(19) United States
(12) Patent Application Publication
(10) Pub. No.: US 2014/0127500 A1
(43) Pub. Date: May 8, 2014

(54) DELAMINATION-AND ABRASION-RESISTANT GLASS WINDOW

(71) Applicant: Schott Corporation, (US)

(72) Inventors: John Carberry, Talbot, TN (US); Katherine Leighton, Media, PA (US); Christopher Snively, Clarks Summit, PA (US); Wiktor Serafin, Boothwyn, PA (US)

(73) Assignee: SCHOTT CORPORATION, Elmsford, NY (US)

(21) Appl. No.: 13/670,174

(22) Filed: Nov. 6, 2012

(51) Int. Cl. B32B 17/10

(52) U.S. Cl. CPC B32B 17/10366; B32B 17/1077; B32B 17/10752; B32B 17/1099
USPC 428/345; 428/426; 428/425.6; 428/412; 428/408; 156/99

(57) ABSTRACT

The transparent window is suitable for use in applications that require a host of very demanding performance criteria. In the window, a transparent polymer is chemically bonded to an adhesive at an interface between the two, which enables the window to resist delamination. The window also has a polymer or plastic strike face with a coating that enables it to endure rigorous field conditions and still pass critical rock strike tests. The window also has a bulk layer with at least one layer of a glass, glass-ceramic, or transparent ceramic material.

### BACKGROUND OF THE DISCLOSURE

1. Field of the Disclosure

The present disclosure relates to transparent windows for use in applications where protection from a variety of incoming projectiles is required. More particularly, the present disclosure relates to a transparent window having a plastic strike face that is treated to be abrasion-resistant, and a chemical bond between adhesive and plastic layer to prevent delamination.

2. Description of the Related Art

The windows used in military vehicles have a number of economic, engineering, and mission-critical functional and operational requirements. Some of these requirements include ballistic protection, ballistic protection against multiple hits, transparency in several light regions (including visible and infra-red), ability to block ultraviolet (UV) light, ability to perform to requirement and survive in extreme temperatures and rapid and severe temperature fluctuations, scratch resistance, and resistance to rock strikes. The United States military document governing transparent armor, ATPD 2532, presents a host of extremely challenging performance requirements.

Engineering a solution to all these requirements while still designing a product that is easily manufactured is extremely challenging. In many cases, satisfying one set of requirements can conflict in terms of engineering and process with other requirements. In some cases this has resulted in engineering compromises that are excessively expensive, especially in terms of the duty lifetimes of these windows.

One example of a particularly difficult design challenge is preventing delamination within the window. Common adhesives and plastic polymers used in windows are hydrophilic, and absorb water. This leads to delamination, since the water wants to exit the material and/or freeze and expand depending on the temperature. The ATPD 2532 document requires a guarantee of five years of delamination resistance, which no manufacturer has been able to satisfy to date.

Another example of a very difficult function to provide concerns the strike face of the window, i.e. the side that faces the incoming projectile. To date, no one has been able to put a plastic material on the strike face of a window. It would be desirable to do so, since a plastic strike face would increase confinement of glass shards. However, the plastic would not pass abrasion, sand erosion, or chemical resistance requirements, would not survive the thermal stresses associated with laminated glass fabrication, and/or would not survive the environment in which the window is used. However, a plastic strike face would provide resistance to rock strike damage at levels which glass will never be able to achieve, would allow very significant reductions in weight, and would better confine the damaged glass. In the four-shot test, one of the tests use to confirm compliance with ATPD standards, the latter feature is valuable to first and third strike, but of enormous value in the second and fourth strikes.

Accordingly, there is a need for a window that can successfully address all of these competing concerns.

### SUMMARY OF THE DISCLOSURE

In one embodiment, the present disclosure provides a multi-layer transparent window. The window comprises: a strike face comprising a front face and a rear face, wherein the strike face comprises a transparent polymer layer and at least one of an organometallic layer and a coating layer adjacent to the transparent polymer; an adhesive layer adjacent to the transparent polymer layer of the strike face; and a bulk layer adjacent to the adhesive layer on an opposite side of the adhesive layer from the adhesive layer, wherein the bulk layer comprises at least one layer of a material selected from the group consisting of glass, glass-ceramic, and transparent ceramic. The adhesive layer is chemically bonded to the transparent polymer layer at a first interface between the adhesive layer and the transparent polymer layer.

In another embodiment, the present disclosure provides a process for preparing a multi-layer transparent window. The process comprises the steps of preparing a bi-laminate of a transparent polymer layer and an adhesive layer, and illuminating the bi-laminate with ultraviolet light, to effect a chemical bond at an interface between the transparent polymer layer and the adhesive layer. The illuminating step can comprise illuminating the bi-laminate with sufficient power to induce an exothermic reaction at the interface, so that a temperature at the interface during the exothermic reaction is between one-hundred-fifty and three hundred degrees Celsius.

In another embodiment, the present disclosure provides a multi-layer transparent window, comprising: a strike face having a front surface and a rear surface, and an adhesive layer chemically bonded to the transparent polymer layer at the rear surface of the strike face. The strike face comprises: a transparent polymer layer; an organometallic layer adjacent to the transparent polymer layer; and a coating layer to form the front surface of the strike face and adjacent to the organometallic layer. The coating layer comprises a material selected from the group consisting of silicon monoxide, silica, silicon nitride, silicon organometallics, diamond like carbon, and combinations thereof.

### BRIEF DESCRIPTION OF THE DRAWINGS

FIG. 1 is a schematic drawing of a first embodiment of the window of the present disclosure;

FIG. 2 is a conceptual drawing of a bond between two layers in the window of FIG. 1;

FIG. 3 if a schematic drawings of a second embodiment of the window of the present disclosure;

FIG. 4 is a plot of the temperature rise for de-icing of a plastic strike face vs. a glass one for a constant heat flux; and

FIG. 5 is a schematic drawing of a third embodiment of the window of the present disclosure.

### DETAILED DESCRIPTION OF THE DISCLOSURE

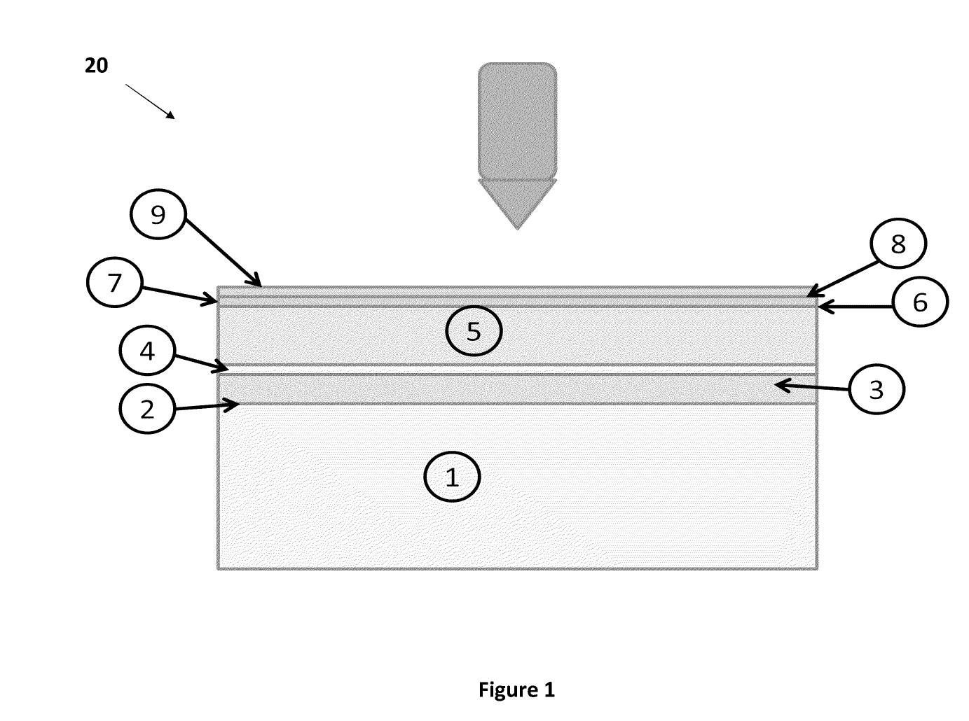

Referring to FIG. 1, window 20 of the present disclosure is shown. Window 20 has bulk layer 1, adhesive layer 3, transparent polymer layer 5, chemical bond promotion later 7, and outer layer 9. As discussed in greater detail below, there are chemical bond interfaces between adhesive layer 3 and transparent polymer layer 5; between transparent polymer layer 5, promotion layer 7, and outer layer 9; and between bulk layer 1 and adhesive layer 3. These chemical bonds help to eliminate significant problems with currently available windows, such as delamination. In addition, outer layer 9 (when present) is applied to transparent polymer layer 5 with the assistance of promotion layer 7, to form a plastic strike face. Coating of the transparent polymer layer 5 with promotion layer 7 and/or outer layer 9 enables the strike face to provide many of the advantages of plastic strike faces described above, while still passing such critical tests as abrasion resistance. Chemically bonding the transparent polymer layer 5 to the adhesive layer 3 via layer 4 enables a transparent polymer plastic strike face that otherwise would not satisfy the required delamination resistance. The multi-layer window 20 of the present disclosure successfully addresses a host of competing concerns with the performance requirements in military applications, and thus provides enormous advantages over currently available windows.

As defined the present disclosure, the term “chemical bond” refers to bonds between two substances where the inter-molecular forces between the two substances are as strong as within one of the substances—which could be Van der Waals, dipole, or hydrogen bonds as examples. Chemical bonds may also be covalent or ionic bonds between two substances. The term “melt bond” refers to a specific type of chemical bond where there is entanglement of long polymer chains between two substances. The terms “surface” or “mechanical” bonds refer to traditional adhesive bonds where two substances that intertwine with each other or carry into grooves of either substance when they are forced together, where the bond between the two substances is not as strong as the intermolecular forces within one of the substances, and where no chemical bonding takes place. The term “strike face” refers to transparent polymer layer 5 when it is coated with promotion layer 7 and/or outer layer 9 and chemically bonded to layer 3.

### I. The Adhesive and Transparent Polymer Layers, and the Chemical Bond Therebetween

Layer 5 comprises a transparent polymer layer. When in use, window 20 will be hit with various projectiles on transparent polymer layer 5, which is coated with promotion layer 7 and/or outer layer 9. Some of the functions of transparent polymer layer 5 include retaining fragments that break off from other layers after impact (for improved multi-hit ballistic performance), keeping the weight of window 20 down, and protecting the layer(s) of glass beneath transparent polymer layer 5 in bulk layer 1 (discussed in further detail below) from cracking or chipping when impacted with a small object like a hand thrown rock.

Suitable transparent plastic polymers for layer 5 include polycarbonate, polymethyl methacrylate (PMMA), poly(methyl 2-methylpropenoate), polyurethane, nylon, or polyimides, each of which is available with or without fiber reinforcement. Transparent polymer layer 5 may have a thickness of six (6) millimeters or less, from one-and-a-half (1.5) millimeters to three (3) millimeters, or any subranges therebetween.

Suitable examples of polycarbonate are sold under the trade names LEXAN® from SABIC, CALIBRE® from Dow Chemicals, MAKROLON® from Bayer, PALGARD® from PALRAM, and PANLITE® from Teijin Chemical Limited, among others. PMMA may be sold under the trade names PLEXIGLASS®, PLEXIGLAS-G®, R-CAST®, PERSPEX®, PLAZCRYL®, LIMACRYL®, AC RYLEX®, ACRYLITE®, ACRYLP LAST®, ALTUGLAS®, POLYCAST® and LUCITE®. PMMA is often also commonly called acrylic glass or simply acrylic. Suitable transparent polyurethanes may be sold by BAE systems under the trade name CrystalGuard®. Transparent polyamides can be sold by Evonik under the trade name Trogamide®.

The transparent polymers of layer 5 may be microcrystalline, where the crystallites are so small light passes through. Examples of this kind of material are Trogamide CX (e.g. Lexan®, Makrolon®). The aforementioned PMMA (also known as acrylic glass), transparent nylon, amides, could also be microcrystalline substances, as a single phase or reinforced with particles or fibers. Polymers reinforced with particles or fibers are known as polymer matrix composites. Thin films, less than 1.5 mm thick, of transparent polymers are also suitable. These could include for example PET (polyethyleneterephthalate), one brand of which is known as Mylar®, and polyester.

Adhesive layer 3 comprises a polymer adhesive. The adhesive can be selected from thermoplastic aliphatic polyurethane, polyvinyl butyral, ethylene/methacrylic acid copolymer, polyvinyl acetal resin, silicone, acrylonitrile-butadiene-styrene (ABS), acetal resin, cellulose acetate, cellulose acetate butyrate, cellulose acetate propionate, cellulose tri-acetate, acrylic, modified acrylic, allyl resin, chlorinated polyether, ethyl cellulose, epoxy, fluoroplastic, ionomers (e.g., Dupont Surlyn A), melamine, nylon, parylene polymer, transparent phenolic, phenoxy resin, polybutylene, polycarbonate, polyester, polyethylene, polyphenylene, polypropylene, polystyrene, polyurethane, polysolphone, polyvinyl-acetate, polyvinyl butyral, silicone, as well as styrene-acrylonitride and styrene-butadiene copolymer. Any transparent adhesive that meets the optical, structural, and chemical bonding requirements of window 20 is suitable.

In one embodiment, to assemble window 20, a bi-laminate of transparent polymer layer 5 and adhesive layer 3 is created first. As discussed in greater detail below, an interface 4 between transparent polymer layer 5 and adhesive layer 3 can comprise either a thin film of a polymer, or one or more transition phases. Interface 4 enables a chemical bond between transparent polymer layer 5 and adhesive layer 3. As discussed in further detail below, the chemical bond created between layers 3 and 5 makes the bond between the two as strong as the materials being bonded, and delamination resistant, as compared to currently available windows. In the latter, any bonds between corresponding layers are mechanical and weaker than the materials being bonded.

One way to create the chemical bond at interface 4 between layers 3 and 5 includes treating transparent polymer layer 5 with a thin coat of monomer and exposing it to light energy to initiate a cationic or free radical polymerization process. The material used in the thin film layer that is applied to transparent polymer layer 5 should therefore contain photoinitiates that become active as free radicals or cations under the light energy. The light energy can be ultraviolet (UV) illumination or visible light, depending on the type of photoinitiates used. The exothermic polymerization in the thin coat initiated by the light energy creates a temperature rise sufficient to cause a reaction to chemically bond with whatever material is in layers 3 and 5. In one embodiment, adhesive layer 3 comprises aliphatic polyurethane, the thin coat applied to transparent polymer layer 5 is acrylated urethane, and transparent polymer layer 5 comprises polycarbonate. The thin coat can be illuminated directly while it is located on transparent polymer layer 5, or it can also be illuminated when it is between transparent polymer layer 5 and adhesive layer 3. In the latter case, the thin coat is preferably illuminated from the side of transparent polymer layer 5—i.e., through transparent polymer layer 5.

Suitable materials for the thin coat used to create interface 4 are transparent monomer or oligomers of acrylated urethane, aliphatic acrylated urethane, epoxy, cyanoacrylate, silicone, vinyl compound, combinations thereof, or other transparent resins with photoinitiate. Suitable photoinitiates for free radical polymerization include alpha-hydroxy ketone, alpha-amino ketone, acyl and bis(acryl)phosphine oxide and for cationic polymerization include aryldiazonium salt, diaryliodonium salt, triarylsulfonium salt, and any combinations of the above. Although these specific compounds may be preferred in a specific application, any compound that helps to initiate the polymerization reaction is suitable.

Illuminating the thin film with photo-energy in this manner creates an exothermic reaction within layer 3 heating interface 4 between layer 3 and 5 and the localized region up to a temperature of from one-hundred-fifty degrees Celsius to three-hundred degrees Celsius or higher. At these temperatures, chemical bonds can form between adhesive layer 3 and transparent polymer layer 5, creating chemical interface 4.

At one-hundred-fifty degrees Celsius, dynamic mechanical analysis of polycarbonate shows a dramatic reduction in the elastic modulus of the polycarbonate. Polyurethane and polycarbonate are one of the few pairs of polymers that are miscible in one another, so they are particularly suitable (though not the only candidates) for the window of the present disclosure. Thus, at this temperature, where the polycarbonate is very soft and the urethane is melted, comingling of the polymer chains occurs making a very strong bond between the two types of polymers. These bonds comprise Van der Waals, dipole, hydrogen bonds, or others such as those between the molecules of each one of the polymers being bonded. Peeling the bi-laminate apart results in the polycarbonate breaking rather than adhesive failure.

At higher temperatures the enthalpy required to get polycarbonate to flow without requiring shear forces drops off dramatically. Yang, in Polymer Engineering and Science, v37, n1, pg 101-104, January 1997, reports an activation enthalpy of four-hundred-thirteen kilojoules per mol at one-hundred-forty-six to one-hundred-seventy degrees Celsius, one-hundred-ninety-seven kilojoules per mol at two hundred degrees Celsius, and one-hundred-eight kilojoules per mol at two-hundred-thirty to two-hundred-seventy degrees Celsius. This effect means the molecules in the polycarbonate will be more and more active and able to co-mingle with the polyurethane in less time as the temperature increases.

At three hundred to three-hundred-twenty degrees Celsius, Lee reports in J. Polym. Sci. Part A, 2, 2859, 1964, that with mass spectrometry and vapor phase chromatography, he determined polycarbonate experiences an oxidation step. This oxidation produces a hydroxyl compound and a free radical which he proposed is associated with oxygen attacking the isopropylidene group of the polycarbonate. Thus, as described above, between temperatures of one-hundred-fifty degrees Celsius to three-hundred-twenty degrees Celsius or higher, chemical bonding to polycarbonate can be achieved through co-mingling, Van der Waals, dipole, or hydrogen interactions between dissimilar polymer molecules, or the formation of covalent or ionic bonds.

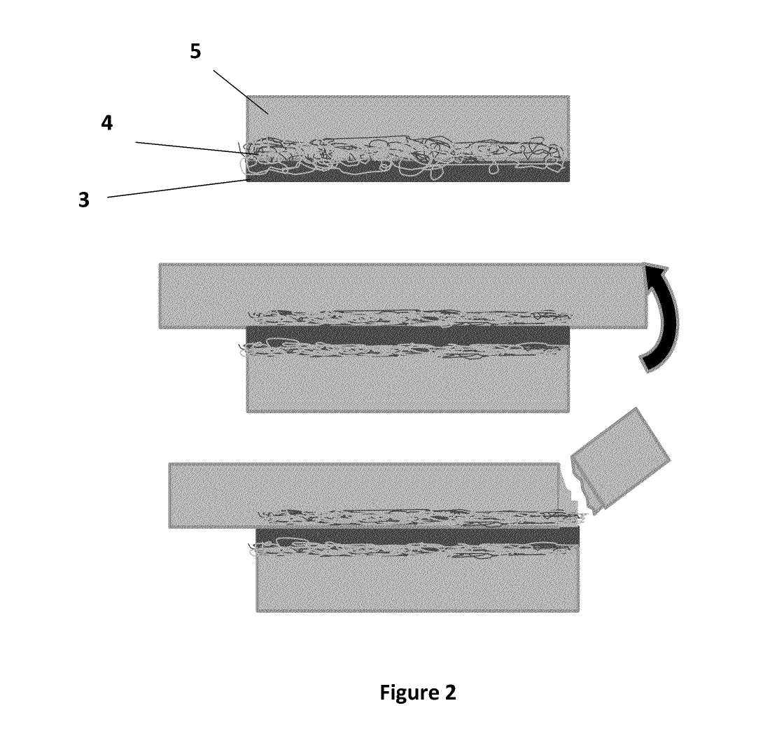

As discussed above, the chemical bond at interface 4 can also be formed with chemical or melt bonding without the thin film of polymer discussed above. In this instance, the transition phase is formed, which may also be known as a graded region of entanglement. A region of entanglement is illustrated in FIG. 2, with transparent polymer layer 5 and adhesive layer 3. The region where strands of the two materials mix together is the entangled region, interface 4. In this entangled region, interface 4, the intermolecular forces between the mixed strands are as strong as bonds between the material in either of layers 3 or 5. Thus, when peeled apart, the material in polymer layer 5 (e.g., polycarbonate) breaks instead of an adhesive failure occurring between layer 5 and adhesive layer 3. In this embodiment, layers 3 and 5 can be heated to a point at which they are miscible in one another, and form a melt bond at interface 4.

This structure of window 20 (i.e., with the chemical bond at interface 4) and the process of preparing it provides enormous advantages over currently available windows. Currently available windows are often prepared by layering polymer adhesive and transparent polymer layers, and then autoclaving the layered structure. The temperatures in autoclave processes are typically around one-hundred-twenty to one-hundred-thirty degrees Celsius. At these temperatures, however, especially for the case of polycarbonate and polyurethane, only mechanical bonds are formed between the polymer and adhesive. Furthermore, with only mechanical bonds between them, both the polymer adhesive and transparent polymer in currently available windows will absorb and saturate with water, at a faster rate if the window is used in an environment with high humidity or the polymers layers were stored in humid environments prior to manufacture. In addition, mechanical deformation, i.e. stress or strain, has been reported to increase solubility and diffusion rates in polymers, so it is likely the water will tend to move toward regions of stress or strain.

If there is a constant source of water in a high humidity environment at elevated temperature, both the polyurethane and polycarbonate will saturate given enough time at a specific temperature. If the temperature fluctuates to low levels, where the saturation level of water in each of the adhesive and transparent polymer is lower, the water will want to come out of each component. The water released in this manner will form as a flat bubble at the interface between the polyurethane and polycarbonate, because the molecular and adhesive forces created by the mechanical bond the water has to overcome at this interface are less than the cohesive forces in the bulk of the material. What may also happen at lower temperatures is that as water freezes and expands, it puts more stress on the mechanical bond at the already stressed point. This is a phenomenon referred to as “freeze-thaw defect formation” in the solar panel industry. Delamination that happens in this manner is extremely costly, as it requires that the window be replaced.

The intermolecular forces in a mechanical bond are much weaker than even the weakest molecular physical forces—namely, Van der Waals forces, which are typically at two to fifteen kilojoules per mol, and four to five nanometers long. Dipole-dipole bonds could be twice as strong as Van der Waals forces, but polycarbonate is not polar, so these dipole-dipole bonds are not present in prior art devices.

The chemical bond between layers 3 and 5 described above and provided by the present disclosure eliminates water source delamination by making the molecular forces in the chemical bond at interface 4 as strong as the molecular forces in the bulk of the material in layers 3 and 5. These molecular forces can include Van der Waals, dipole-dipole bonds, or hydrogen bonds which have bond strengths of twenty to thirty kilojoules per mol, are on the order of 0.2 nanometers long, or produce the transition phase described above. The UV illumination process described above may also result in the breaking of bonds in the transparent polymer layer 5, creating radicals or cations free for bonding. If this happens, covalent bonds that are on the order of one hundred fifty to nine hundred kilojoules per mol and 0.1 to 0.2 nanometers long might be created at interface 4.

The chemical bond at interface 4 described above could be achieved by heating adhesive layer 3 and transparent polymer layer 5 to the desired temperature (e.g., three hundred degrees Celsius) after they have been adhered together. However, this is extremely impractical from a manufacturing standpoint. Furthermore, heating layers 3 and 5 in this manner would subject them to residual stresses at room temperature, which would cause failures. In the process of the present disclosure, the bonding at interface 4 is induced by creating the chemical reaction between layers 3 and 5 in situ. The exothermic reaction also occurs locally at interface 4, so all of layers 3 and 5 are not subject to damaging thermal stresses.

The bond at interface 4 is so strong that when layers 3 and 5 are pulled apart, the materials in each layer will rupture or tear before the bond severs (as shown in FIG. 2). Again, this presents a significant improvement over currently available windows, which delaminate in the manner described above, known as adhesive failure, because of the comparatively weak mechanical bond between layers.

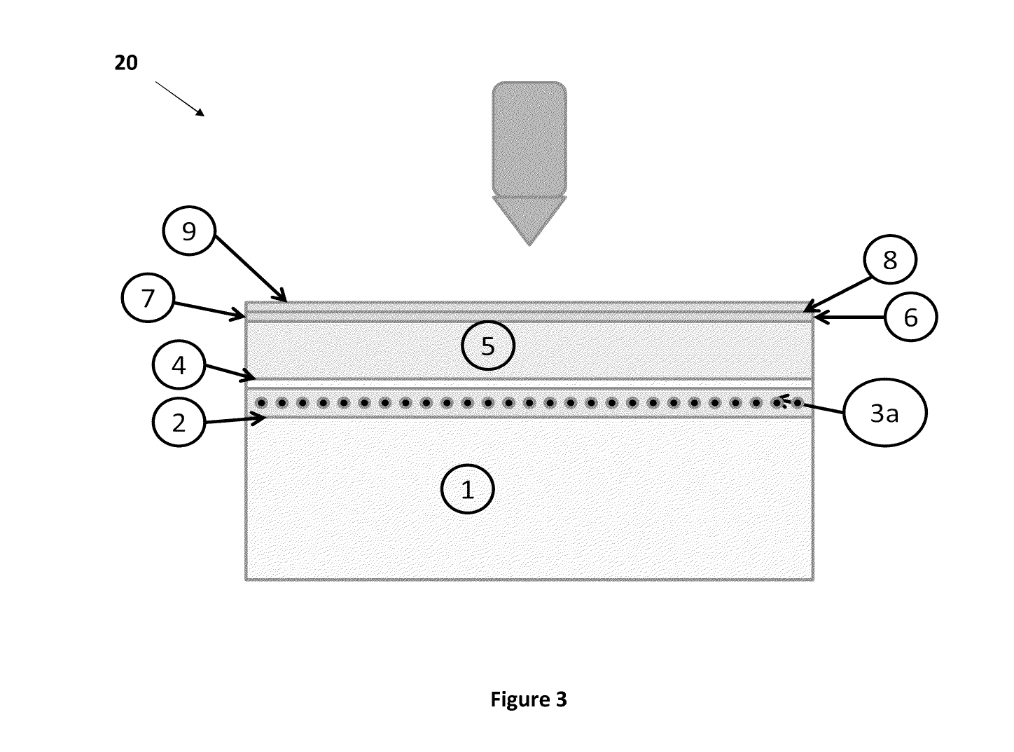

FIG. 3 shows an embodiment of window 20 having a de-icer layer 3a. Layer 3a comprises the adhesives described above with respect to layer 3, and also a component that can assist in the de-icing of window 20. This component can be a traditional wire embedded de-icier mat where small diameter resistive wires are laid down in a pattern and attached to bus bars leading to connectors that plug into a vehicles electrical system (not shown). The de-icing component may also be a deposition of a thin electrically conductive film such indium-tin-oxide, or tin-oxide. Lastly, the de-icing component may be a transparent electrically conductive layer comprised of nano-particles of an electrically conductive metal or semi-conductor dispersed in the UV excited cationic or free radical polymer.

A thin, elastic strike face also enables the use of pulse electro-thermal deicing or electro-impulse deicing. A thin, plastic strike face also enables rapid de-icing. A typical borosilicate glass strike face would be on the order of nine millimeters, whereas a plastic strike face may have a thickness of only three millimeters. Borosilcate glass has a density of 2.2 grams/cubic centimeter, where polycarbonate has a density of 1.2 grams/cubic centimeter. So at a third of the thickness and approximately half the density, a plastic strike face represents a sixth of the mass to be heated by the de-icer.

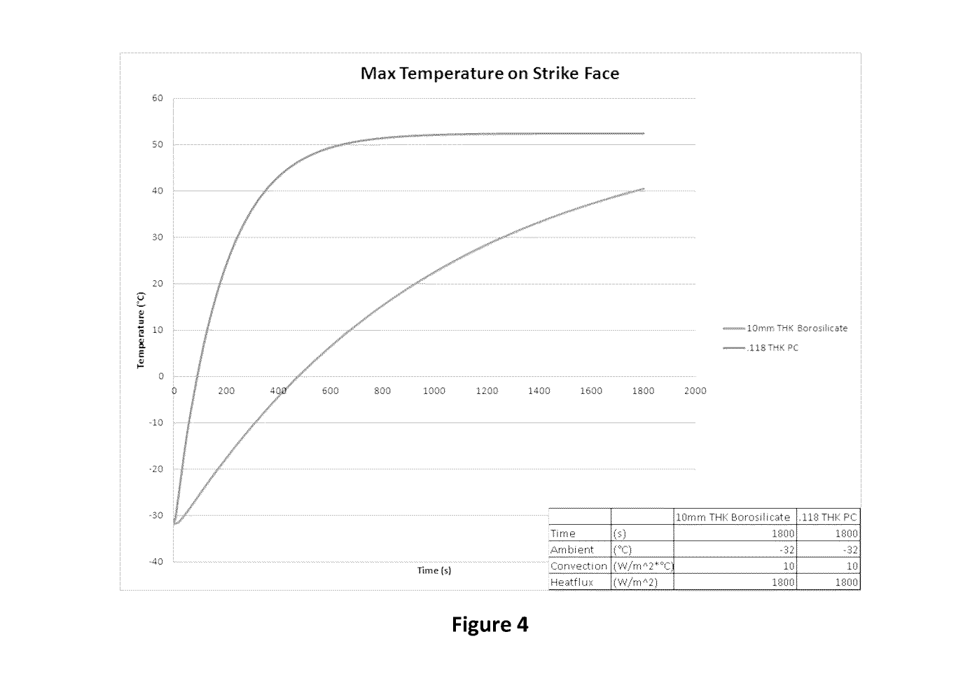

Finite Element Analysis of this effect on heating in one example is shown in FIG. 4 below comparing 10 mm Glass to 3 mm PC using a flux of 1800 W/m̂2, convection of 10 W/(m̂2*deg C.) @ −32 deg C. and 30 minutes (1800 seconds). This analysis shows that the plastic strike face reaches a temperature at which ice begins to melt (zero deg C.) in about ⅕^{th} of the time the glass surface takes to reach this same temperature.

### II. The Strike Face

Transparent polymer layer 5, together with promotion layer 7 and/or outer layer 9, combined with the chemical bond to layer 3, forms a strike face with functionality that a bare polymer or glass layer lacks—namely, as described in the Background section above, the ability to resist damage from rock strike or small object impacts. The strike face of the present disclosure also resists delamination, heats up faster to de-ice faster, and retains glass fragments from previous shots enabling lighter weight solutions for multi-hit. The strike face of the present disclosure provides this functionality while still providing the advantages of other polymers and which are required in military applications, namely scratch or erosion resistance, chemical resistance, and temperature stress resistance.

As shown in FIG. 1, layer 7 is disposed between outer layer 9 and transparent polymer layer 5. Chemical bonds are created between the layers are at interfaces 6 and 8.

In one embodiment, promotion layer 7 is an organometallic compound. This organometallic compound chemically bonds to transparent polymer layer 5 at interface 6, and enables chemical bonding to layer 9 at interface 8. In one embodiment, the organometallic material of layer 7 is a silicon-based polymer known as polysiloxane. The thickness of layer 7 can be from several molecules thick up to one hundred microns, or any subranges therebetween. As described above, transparent polymer layer 5 can be polycarbonate. Suitable polysiloxane coated polycarbonates include Bayer's Makrolon®-AR, SABIC's LEXAN® MR101, HLG5, and HLG3A.

Polysiloxanes can be chemically bonded to polycarbonate in a few ways. U.S. Pat. No. 5,554,702 teaches a polymeric coupling agent, where an epoxidized silane is reacted with polycarbonate in the presence of a quaternary ammonium salt. U.S. Pat. No. 4,232,088 teaches a primer layer on polycarbonate onto which a polysiloxane coating is applied. Not all polysiloxane coated polycarbonates are suitable. Some polysiloxane coatings applied as a lacquer by flow coating or dip coating without sufficient post curing do not exhibit chemical bonding of the coating to the polycarbonate and are observed to crack or flake off within a few years or less, in environmental tests in hot humid environments, under thermal shock conditions, or during the autoclave process that is subsequently used to bond to bulk layer 3 (described in further detail below).

Chemical bond promotion layer 7 preferably includes additives, such as nano sized minerals. These nano-sized minerals may include oxides such as silica or titania. The oxides are preferably less than 100 nanometers in diameter, and more preferably less than 50 nanometers in diameter. These sizes are important to maintain transparency. These additives in layer 7 decrease the coefficient of thermal expansion thereof to a level between that of layer 5 and layer 9. This minimizes the stresses due to differences in thermal expansion that will develop over temperature cycles or during exposure to thermal shock environments and which may lead to delaminating or cracking of the coating(s).

UV additives can be added to one or more of the layers of the strike face. As used herein, the term “UV additive” means a compound that helps to minimize the effects of UV radiation on the layers and chemical bonds in window 20. These additives can be, but are not limited to, compounds that absorb UV themselves, or that hinder the process of the degradation caused by UV in some other way.

UV additives are not requirements in window 20, but can be very helpful to achieve long life against delamination. Without UV additives, the heat generated by the UV exposure can break the bonds holding the coating layer 7 to the transparent plastic of transparent polymer layer 5. The UV absorbers can be implemented in window 20 in one of three ways: 1) additives to transparent polymer layer 5, 2) additives to promotion layer 7, and 3) co-extrusion of a “cap” layer onto the strike face side of transparent polymer layer 5, with a heavy concentration of UV additives. The concentration of UV additives in the latter embodiment may be up to 1 wt %, or any subranges thereof.

Suitable UV additives are shown in Table 1 below depending on the polymer of layers 7 and 5. The first four listed absorb UV. HALS, Hindered Amine Light Stabilizers, do not absorb UV but form nitroxyl radicals that scavenge the products of photodegradation and hinder the degradation process. Other important UV absorbing compounds include hydroxyphenyl benzotriazoles; hydroxyphenyl-s-triazines; oxalanilides; and 2-hydroxybenzophenones and the widely used 2-(2-hydroxyphenyl)-benzotriazole. Specific examples of suitable clear or transparent additives include Cyasorb UV-3638F from Cytec, Uvinul® 3030 is a cyanoacrylate from BASF, Tinuven 360 is a benzotriazole from Ciba, and U.S. Pat. No. 5,391,795 teaches silynated agents 4,6,-dibenzoyl-z-(trialkoxysilylalkyl).

TABLE 1

| UV Additive | Epoxies | PC | TPU | PMMA | PET/PETG | Thermoset PU |
|---|---|---|---|---|---|---|
| Benzoate | | X | X | X | X | |
| Benzophenone | X | X | | X | X | X |
| Benzotriazole | X | X | X | X | X | X |
| Cyanoacrylate | | X | | X | X | X |
| HALS | X | X | X | X | X | X |
| Nickel | | X | | | | |
| Zn Compounds | | X | | | | |

PC is polycarbonate, TPU is transparent polyurethane, PMMA is polymethyl methacrylate, PET/PETG is polyethyleneterephthalate/glycol-modified polyethyleneterephthalate, and PU is polyurethane.

Outer layer 9 can be made of any transparent material with the required properties (abrasion resistance, transmission, chemical resistance, ability to chemically bond to the next layer) described earlier. Outer layer 9 may comprise one or more metals, oxides, ceramics, nitrides, carbides, and organometallics. Specific examples for the material of layer 9 include silicon monoxide (SiO), silica (silicon dioxide, SiO2), silicon nitride (Si3N4), silicon organometallic, or carbon containing Si—O compounds. One example of the latter is diamond like carbon (DLC). Outer layer 9 is on the order of microns thick. It can be from several molecules thick, or up to one hundred microns thick, or any subranges therebetween. In one embodiment, layer 9 is from four to seven microns thick.

Layer 9 is applied to promotion layer 7 with a chemical vapor deposition process or a plasma-enhanced chemical vapor deposition process, and after application forms a chemical bond with promotion layer 7 at interface 8. The material of outer layer 9 forms a chemical bond with the material of promotion layer 7 as a result of the plasma exciting species on the surface of promotion layer 7, and enabling silicon based organometallic chemistry between those excited species and the depositing vapors of layer 9.

Outer layer 9 can comprise one or more layers of the materials described above. In some embodiments, there are two or three such layers. Polycarbonate, such as that in transparent polymer layer 5, will typically not break or crack under the conditions where window 20 is used. However, in coating polycarbonate with a glassy or ceramic-like coating in the manner described above with respect to layer 9, there is a concern that the coating is too thick and may act like a glass and crack. In the present disclosure, testing was conducted with a chemical vapor deposition process that laid down twenty-two layers; the top most layer of which was silicon dioxide. This thick, hard coating scuffed and showed no signs of cracking when impacted with a hard hand thrown rock. It was thermal cycled to low temperature between −25 and −54 deg C. and still showed no signs of cracking. Thus, even with multiple strike face layers, window 20 performs to requirements.

The resulting strike face provides significantly improved scratch and rock strike resistance, and delamination resistance over currently available windows, thus significantly extending the life of window 20. In addition, by manipulating the indices of refraction used in window 20 and specifically outer layer 9, window 20 can be transparent looking out from the safe side and reflective looking in from the strike face side. This also protects the personnel protected by window 20 from being seen.

Furthermore, coating window 20 with outer layer 9 in the manner described above creates a barrier between the exterior environment and the transparent polymer in layer 5 (e.g., polycarbonate). This barrier protects transparent polymer layer 5 from chemicals that could cause it harm. For example, with layer 9, window 20 would be resistant to petroleum distillates as well as the other common cleaning and environmental chemicals experienced by a window.

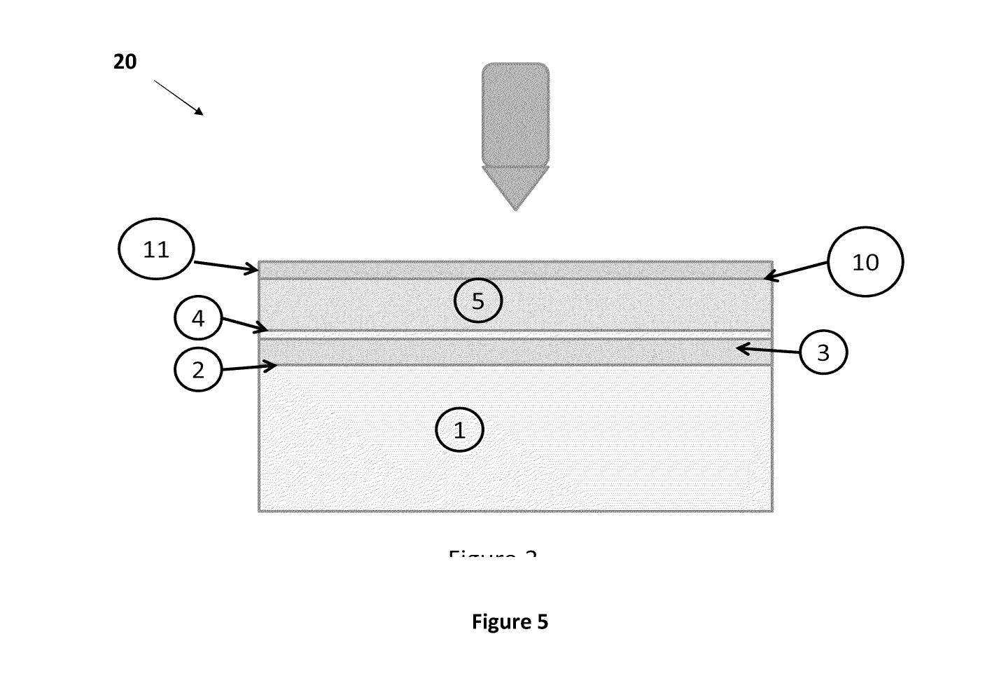

Some advanced coatings used in promotion layer 7, especially those reinforced with the nano-particle mineral reinforcements described above, exhibit sufficient resistance to be used alone (i.e., without being protected by outer layer 9). Such an embodiment is shown in FIG. 5. Layer 11 in this embodiment is chemically bonded to transparent polymer layer 5 at interface 10. Layer 11 can include polysiloxane, or other transparent polymers such as those described above with respect to transparent polymer layer 5, that have a dispersion of the nanosized minerals described above with respect to promotion layer 7.

### III. The Bulk Layer, the Adhesive Layer, and the Chemical Bond Therebetween

Bulk layer 1 comprises at least one layer of a glass, glass-ceramic, or transparent ceramic. Suitable glass materials include soda lime glass, low iron soda lime glass (e.g. Starphire® or Optiwhite®), or borosilicate glass (e.g. Borofloat® 33 or Borofloat® 40). Suitable glass-ceramics include lithium aluminosilicate glass, and aluminosilicate glass. Glass-ceramic materials can also include those having a crystalline phase of Beta-quartz, spinel, Beta-willemite, forsterite, spinel solid solution, mullite, and similar glass ceramics. Examples of these glass-ceramic materials are sold as Robax®, Resistan®, and Zerodur®. Suitable transparent ceramics are sold under the trade names Spinel® or ALON®. The overall thickness of bulk layer 1 can be from five millimeters to fifty millimeters.

A chemical bond between bulk layer 1 and adhesive layer 3 is created at an interface 2. In one embodiment, bulk layer 1 comprises glass or glass-ceramic, and adhesive layer 3 comprises aliphatic polyurethane. Silanol additives can be included with the materials described above for adhesive layer 3, or can be added to a wash that is applied to bulk layer 1 before bonding. To form the chemical bond, window 20 can be prepared in an autoclave process. Bulk layer 1 may also be attached to the bi-laminate discussed above Section I.

Hydroxylation occurs at interface 2 by water chemically reacting with dangling silicon cations or the silicon monoxide anions in bulk layer 1, by hydrolysis of siloxane linkages, or through ion exchange at non bridging oxygen sites. These hydroxylated surfaces are highly reactive with silanols, and will form strong covalent bonds.

Bulk layer 1 faces the interior of the area to be protected by window 20, opposite to outer layer 9 (when present), on what is known as the “safe side”. The glass or ceramic material in layer 1, when impacted by a projectile hitting strike face 20, may splinter or fragment on the safe side, producing small glass or ceramic fragments known as spall. In some applications, it is not critical to limit or catch the spall, since personnel will not typically be located in the immediate area of window 20. In some applications, however (for example vehicles), personnel will be very close to window 20 on the safe side, and in this instance spall must be severely limited if not completely eliminated. For these applications, bulk layer 1 can have an additional layer of transparent polymer, similar to transparent polymer layer 5 described above. When window 20 is assembled, the transparent polymer and glass, glass-ceramic, or transparent ceramic layer or layers in bulk layer 1 are assembled and chemically bonded to one another with an adhesive in the manner described above with respect to layers 1, 3, and 5.

### IV. Experimental Data

a. Chemical Bond Between Polymer Layer 5 and Adhesive Layer 3

In an adhesion test, a 3″×3″ square base of 0.22″ thick polycarbonate was bonded to a 1″×5″ bar of 0.22″ thick polycarbonate that over hangs the base by 1″ on each side. A pressure cylinder devise applies a torque to the underside of the overhang region to peel the bar off of the base. A pressure gage indicates the level needed to debond the sample. Visual inspection and microscopy is used to determine the type of failure; which could be adhesive, cohesive, mixed mode or substrate failure.

Examples of the bond failures in autoclaved aliphatic thermoplastic polyurethane bonds and the same type of bonds with co-mingled polymer bonds created by conformal coatings for processing at temperature above the viscosity drop temp are shown below in Table 1. As mentioned above, the problem with the conformal coatings are the optical properties. The problem with the one-hundred-fifty degree processing is that repeated exposure may weaken the polycarbonate, and processing at these high temperatures result in deleterious residual stresses.

TABLE 1
Prior art bonds.

| | | | Interlayer | | | Relative | Start of | Max | |
|---|---|---|---|---|---|---|---|---|---|
| Test | Sample | Interlayer | Thickness | Additional | Temperature | Humidity | Delam | Pressure | |
| Da [symbol] [symbol] | ID [symbol] | Type [symbol] | (in) [symbol] | Description [symbol] | (deg C.) [symbol] | ( [symbol] [symbol] | (psi) [symbol] | (psi) [symbol] | Comments [symbol] |
| Jan. 31, 2012 | 1 | Aliphatic | 0.025 | Unmilled Test | Ambient | Uncontrolled | 1000 | 2000 | adhesive |
| | | TPU-hard | | Sample | | | | | |
| Dec. 7, 2011 | 1 | Aliphatic | 0.025 | | Ambient | Uncontrolled | 800 | 1200 | adhesive |
| | | TPU-hard | | | | | | | |
| Dec. 7, 2011 | 2 | Aliphatic | 0.025 | | Ambient | Uncontrolled | 600 | 1200 | adhesive |
| | | TPU-hard | | | | | | | |
| Dec. 7, 2011 | 3 | Aliphatic | 0.025 | | Ambient | Uncontrolled | 400 | 1400 | adhesive |
| | | TPU-hard | | | | | | | |
| Dec. 7, 2011 | 4 | Aliphatic | 0.025 | | Ambient | Uncontrolled | 200 | 1400 | adhesive |
| | | TPU-hard | | | | | | | |
| Dec. 7, 2011 | 5 | Aliphatic | 0.025 | | Ambient | Uncontrolled | 500 | 1500 | adhesive |
| | | TPU-hard | | | | | | | |
| Dec. 7, 2011 | 6 | Aliphatic | 0.025 | | Ambient | Uncontrolled | 400 | 1300 | adhesive |
| | | TPU-hard | | | | | | | |
| Dec. 7, 2011 | 7 | Aliphatic | 0.025 | | Ambient | Uncontrolled | 500 | 1500 | adhesive |
| | | TPU-hard | | | | | | | |
| Dec. 7, 2011 | 8 | Aliphatic | 0.025 | | Ambient | Uncontrolled | 500 | 1400 | adhesive |
| | | TPU-hard | | | | | | | |
| Dec. 7, 2011 | 9 | Aliphatic | 0.025 | | Ambient | Uncontrolled | 500 | 1500 | adhesive |
| | | TPU-hard | | | | | | | |
| Dec. 7, 2011 | 10 | Aliphatic | 0.025 | | Ambient | Uncontrolled | 500 | 1400 | adhesive |
| | | TPU-hard | | | | | | | |
| Feb. 13, 2012 | 7 | Aliphatic | 0.025 | Conformal | Ambient | Uncontrolled | 200 | 1700 | adhesive/cohesive |
| | | TPU-hard | | Coating ″1″ | | | | | |
| Feb. 13, 2012 | 8 | Aliphatic | 0.025 | Conformal | Ambient | Uncontrolled | 400 | 1800 | adhesive/cohesive |
| | | TPU-hard | | Coating ″1″ | | | | | |
| Feb. 13, 2012 | 9 | Aliphatic | 0.025 | Conformal | Ambient | Uncontrolled | 100 | 1700 | adhesive/cohesive |
| | | TPU-hard | | Coating ″2″ | | | | | |
| Feb. 13, 2012 | 10 | Aliphatic | 0.025 | Conformal | Ambient | Uncontrolled | 100 | 1700 | adhesive/cohesive |
| | | TPU-hard | | Coating ″2″ | | | | | |
| Feb. 13, 2012 | 11 | Aliphatic | 0.025 | Conformal | Ambient | Uncontrolled | 300 | 1800 | adhesive/cohesive |
| | | TPU-hard | | Coating ″3″ | | | | | |
| Feb. 13, 2012 | 12 | Aliphatic | 0.025 | Conformal | Ambient | Uncontrolled | 100 | 1800 | adhesive/cohesive |
| | | TPU-hard | | Coating ″3″ | | | | | Snapped PC ~1″ |
| | | | | | | | | | back from |
| Apr. 19, 2012 | 11 | Aliphatic | 0.025 | PC-PC; Dry PC, | Ambient | Uncontrolled | 580 | 1200 | edge |
| | | TPU-hard | | ATC @150 C. | | | | | |
| Apr. 19, 2012 | 12 | Aliphatic | 0.025 | PC-PC; Dry PC, | Ambient | Uncontrolled | 280 | 1800 | Snapped PC |
| | | TPU-hard | | ATC @150 C. | | | | | |
| Apr. 19, 2012 | 13 | Aliphatic | 0.025 | PC-PC; Dry PC, | Ambient | Uncontrolled | 480 | 2200 | Snapped PC |
| | | TPU-hard | | ATC @150 C. | | | | | |
| Apr. 19, 2012 | 14 | Aliphatic | 0.025 | PC-PC; Dry PC, | Ambient | Uncontrolled | 340 | 1200 | Snapped PC |
| | | TPU-hard | | ATC @150 C. | | | | | |
| Apr. 19, 2012 | 15 | Aliphatic | 0.025 | PC-PC; Dry PC, | Ambient | Uncontrolled | 260 | 1400 | Snapped PC |
| | | TPU-hard | | ATC @150 C. | | | | | Stutter Snapped, |
| | | | | | | | | | then |
| Apr. 19, 2012 | 16 | Aliphatic | 0.025 | PC-PC; Dry PC, | Ambient | Uncontrolled | 360 | 1300 | debond |
| | | TPU-hard | | ATC @140 C. | | | | | Stutter Snapped, |
| | | | | | | | | | then |
| Apr. 19, 2012 | 17 | Aliphatic | 0.025 | PC-PC; Dry PC, | Ambient | Uncontrolled | 340 | 1400 | debond |
| | | TPU-hard | | ATC @140 C. | | | | | Stutter Snapped, |
| | | | | | | | | | then |
| Apr. 19, 2012 | 18 | Aliphatic | 0.025 | PC-PC; Dry PC, | Ambient | Uncontrolled | 420 | 1400 | debond |
| | | TPU-hard | | ATC @140 C. | | | | | |
| Apr. 19, 2012 | 19 | Aliphatic | 0.025 | PC-PC; Dry PC, | Ambient | Uncontrolled | 320 | 1300 | NO BREAK |
| | | TPU-hard | | ATC @140 C. | | | | | Stutter Snapped, |
| | | | | | | | | | then |
| Apr. 19, 2012 | 20 | Aliphatic | 0.025 | PC-PC; Dry PC, | Ambient | Uncontrolled | 260 | 1300 | debond |
| | | TPU-hard | | ATC @140 C. | | | | | |

[symbol]

indicates data missing or illegible when filed

Test results on samples made according to the present disclosure are shown in Table 2. There are several kinds of failures other than bond failures: mixed mode, cohesive, and even substrate failure (i.e., the breaking of the polycarbonate).

TABLE 2

| Specimen | | | | Photoenergy | Post Thermal | |
|---|---|---|---|---|---|---|
| No. | Coating | Specimen lay-up | Application process | (mW-min/cm\hat{ }2) | Exposure | Bond Result |
| prior art | none | .22″ PC/0.015″TPU/ | none | none | 120 deg C. at 95 psi | adhesive failure |
| | | .22″PC | | | | both sides |
| 71 | ionic photoinitiate | .22″ PC/coating/0.015″ | coating applied like an | >338 | 120 deg C. at 95 psi | cohesive |
| | 3850 | TPU/coating/.22″PC | adhesive between the PC | | | |
| 72 | | | and TPU | | | mixed mode |
| 76 | | | coating applied with dr. | >338 | 120 deg C. at 95 psi | cohesive |
| | | | blade to each PC surface, | | | |
| 75 | | | and photinitiated, then TPU | | 120 deg C. at 95 psi | mixed mode |
| | | | sandwiched in between. | | | |
| 73 | | .22″ PC/coating/0.015″ | applied like an adhesive to | >338 | 120 deg C. at 95 psi | mixed mode |
| | | TPU/.22″PC | one side only | | | |
| 52 | | PC/coating/PC | applied like an adhesive | 225 | none | cohesive |
| 34 | | PC/coating/PC | | 225 | none | adhesive one side |
| 44 | Urethane Acrylate | PC/coating/PC | | 225 | none | mixed mode |
| 45 | with photoinitiates, 65 | PC/coating/PC | | 225 | none | PC failed |
| 24 | | PC/coating/PC | | 225 | none | adhesive one side |
| 78 | ionic photoinitiate | .22″ PC/coating/0.015″ | coating applied with dr. | >338 | 120 deg C. at 95 psi | cohesive |
| 102 | 3850 | TPU/coating/.22″PC | blade to each PC surface, | | | mixed mode |
| 79 | | .22″ PC/coating/0.025″ | and photinitiated, then TPU | | | mixed mode |
| 103 | | TPU/coating/.22″PC | sandwiched in between. | | | mixed mode |
| 80 | | .22″ PC/coating/0.05″ | | | | mixed mode |
| 104 | | TPU/coating/.22″PC | | | | mixed mode |
| 81 | | .22″ PC/coating/0.03″ | | | | mixed mode |
| 105 | | TPU/coating/.22″PC | | | | mixed mode |
| 82 | photoinitiate 450 | .22″ PC/coating/0.015″ | | | | adhesive |
| 86 | Urethane Acrylate 65 | TPU/coating/.22″PC | | | | adhesive |
| 90 | Urethane Acrylate 80 | | | | | some mixed |
| 83 | photoinitiate 450 | .22″ PC/coating/0.025″ | | | | adhesive |
| 87 | Urethane Acrylate 65 | TPU/coating/.22″PC | | | | adhesive |
| 91 | Urethane Acrylate 80 | | | | | some mixed |
| 84 | photoinitiate 450 | .22″ PC/coating/0.05″ | | | | adhesive |
| 88 | Urethane Acrylate 65 | TPU/coating/.22″PC | | | | adhesive |
| 92 | Urethane Acrylate 80 | | | | | mixed mode |
| 85 | photoinitiate 450 | .22″ PC/coating/0.03″ | | | | adhesive |
| 89 | Urethane Acrylate 65 | TPU/coating/.22″PC | | | | adhesive |
| 93 | Urethane Acrylate 80 | | | | | some mixed |
| 116 | Urethane Acrylate | PC/coating/PC | applied like an adhesive in | >338 | | cohesive |
| 117 | 3500 | | an inert gas (He) | >225 | | cohesive |
| 118 | | | atmosphere | >167 | none | mixed mode then |
| | | | | | | PC broke |
| 119 | | | | >112 | | mixed mode then |
| | | | | | | PC broke |
| 120 | | | | >56 | | mixed mode then |
| | | | | | | PC broke |
| 232 | Urethane Acrylate | .22″ PC/coating/0.025″ | coating applied to each PC | >675 | none | mixed mode |
| | 3069 | TPU/coating/.22″PC | surface, TPU sandwiched in | each side | | |
| 233 | | .22″ PC/coating/0.05″ | between, exposed to UV | >506 | | cohesive |
| | | TPU/coating/.22″PC | from each side. | each side | nine | |

It is important that the exothermic bonding approach provide chemical bonds, which is evidenced in Table 2 by non-adhesive failure. The optical transmission should also remain as high as possible.

For the prior art bond sample in Table 2 the photopic transmission based on illuminate A is 89.9% and the night vision goggle (NVG) transmission is 89.5%. For the others in Table 2, the photopic transmission ranged from 85% to 90%, and the NVG from 82% to 90%.

The data in Table 2 shows that even with the structure described above, sometimes adhesive failure indicative of a mechanical bond occurred. To ensure consistent chemical bonding the preferred practice is to prepare (lay-up) the samples under an inert gas such as helium, argon, or nitrogen to avoid having cations or radicals react with oxygen. In addition, in the embodiment where adhesive layer 3 comprises polyurethane, more power (i.e., UV photoenergy) is needed to achieve the desired bonding. In the last seven samples of Table 2, where an inert gas or higher power was used, each sample exhibited failure mode other than adhesive.

The present disclosure also contemplates an alternative to ensure bonding to the polyurethane adhesive layer. In this embodiment, some of the adhesive thermal plastic polyurethane is ground up and mixed in with the coating. This achieves a higher surface area of contact with the coating during the cationic reaction phase, and encourages melt bonding of the polyurethane particles to the film of polyurethane adhesive in the areas where they contact during the subsequent autoclave processes.

b. Strike Face

Resistance to cracking against small object impacts was evaluated with several different tests. In one, a 20 gram, 19-20 mm diameter, 30-31 mm long 2017 A grade aluminum object with a 90 degree conical nose comprising 9-11 mm of the tip was launched to impact the face of a laminated glass specimen at one-hundred-forty-three meters per second. This is known as the French Gravel test. Under these conditions glass layers typically crack, exhibiting cone cracks, medial cracks, a central crush zone, and sometimes long radial cracks. These effects can be minimized if the glass layer is thick enough (typically over 5 mm, and often requiring 10 mm or more) and/or has a chemically strengthened surface layer.

In the windows of the present disclosure, even with a thin (thirty mils and less) polymer sheet adhered to standard annealed glass there is no glass cracking of any type. When the polymer facing is this thin, it may tear and bunch up, but the glass still does not break. With thicker polymer layers, (e.g., 0.22″ polycarbonate), this particular projectile leaves an indentation. While these indentations and tears in polymers are not as desirable as no damage, they have the advantage that they do not grow or propagate into long cracks, which are the biggest problem with interfering with vision.

In another test, rocks are characterized for geology and mass and a mass of typically 120-160 grams is used. These rocks are dropped or thrown at prescribed distances to generate various impact energy situations on samples comprised of single layers, bilaminates, and multiple layered laminates. It was observed that glass, even chemically strengthened thick glass, is scuffed or chipped from a vertical drop and that with the best chemically strengthened glasses it may take a drop height over 10 feet with a 130 gram rock to create anything more severe than a scuff. Similarly, with a 1.75″ steel ball the best chemically strengthened glass or glass-ceramics show no damage until a drop height of over 10 feet and some up to 20 feet. With this same rock or steel ball, however, dropped with a combined rotational motion can create a cone crack and small radial cracks from a drop less than one foot.

Polycarbonate will not break or crack under these conditions. When one coats the polycarbonate, however, with a glassy or ceramic like coating to achieve the desired glass like abrasion resistance, and if this coating is too thick it may act like a glass and the coating may crack. In the present disclosure, as described above, polycarbonate coated by a plasma enhanced CVD process that laid down many layers was tested, the top most layer comprising silicon dioxide. This thick, hard coating scuffed and showed no signs of cracking when impacted with a hard hand thrown rock. It was thermal cycled to low temperature between −25 and −54 deg C. and still showed no signs of cracking.

This same coated polycarbonate was tested against a 12.7 mm diameter silicon nitride ball traveling over 60 ft/sec, a velocity which typically creates a ring crack, cone crack or more severe crack in chemically strengthened soda lime silicate or borosilicate glass, and we observed no damage.

A final test is to swing a pointed steel impactor mounted on a pendulum into the surface of the sample. The impator is 0.3″ diameter steel hardened to RC60 and having an ogive nose tip. This test creates a small, on the order of 3 mm, chip in glass or glass ceramic surfaces. Depending on the type of glass and the sample construction, single ply, bilaminate, or multiple ply laminate, this chip will grow into a long crack when thermal cycled to low temperatures in the range of −25 to −54 deg C. However, when the multi-layer hard coated polycarbonate prepared according to the present disclosure was impacted in this test, it produced small indents that did not develop into any more severe damage.

The abrasion test generally used is a Taber abrasion machine with CS-10F wheels loaded with 500 grams on each wheel. The extent of the abrasion on reducing visibility is determined by change in haze measured using a Hazegard from BykGardner. Data for this test is shown in Table 3 along with optical data.

TABLE 3
Optical properties and haze results for polycarbonate with abrasion resistant
coatings compared to glass and bare polycarbonate.

| | | | | | Change in Haze | | |
|---|---|---|---|---|---|---|---|
| | Thick | Initial Optical Properties | | | Cycles with 10 CSF 500 gr ea | | |
| Material | (mm) | Photopic | NVG | Haze | 100 | 500 | 1000 |
| Annealed soda lime glass | 5.6 | 91.2 | na | 0.46 | na | na | 2.35 |
| Annealed borosilicate glass | 3 | 92.6 | na | 0.48 | na | na | 0.68 |
| Glass-ceramic | 4 | 86.9 | na | 0.48 | na | na | 1.31 |
| Tempered borosilicate | 3 | 92.7 | na | 0.48 | na | na | 0.63 |
| Polished glass-ceramic | 8 | 86.8 | na | 0.39 | na | na | 0.94 |
| bare polycarbonate | 1.6 | 88.3 | 89.13 | 0.37 | 23.57 | 24.87 | 27.1 |
| siloxane coated polycarbonate | 1.4 | 93.1 | 93.8 | 0.54 | 1.48 | 3.74 | 5.15 |
| siloxane coated polycarbonate | 3 | 89.3 | 90.2 | 0.74 | 2.6 | 5.4 | 7.3 |
| siloxane coated polycarbonate | 3 | 89.6 | 90.9 | 0.33 | 1.23 | 2.92 | 4.41 |
| advanced siloxane coated | 3 | 90.5 | 91.5 | 0.15 | 0.78 | 1.33 | 1.81 |
| polycarbonate | | | | | | | |
| nano-dispersed oxide coated | 3 | na | na | 0.4 | na | 0.7 | 0.8 |
| polycarbonate | | | | | | | |
| PECVD Si—O coated | 3 | na | na | 0.2 | 1.6 | 1 | <2 |
| polycarbonate | | | | | | | |
| PECVD DLC + polysiloxane | 3 | 89.9 | 92 | 1.375 | 0.217 | 0.417 | 0.367 |
| coated polycarbonate | | | | | | | |

These data show the feasibility of achieving a coated polycarbonate (i.e., according to the present disclosure) with abrasion resistance equal or better than glass either by using an advanced polysiloxane coating, a nano-dispersed oxide or CVD coating with a material such as Si—O, DLC, or other material such as silicon nitride that is harder than silicon dioxide or siloxane.

The chemical resistance of PECVD DLC+polysiloxane coated polycarbonate to diesel fuel, motor oil, and household glass cleaner by putting several drops of each chemical on the surface and covering each one with a watch glass to capture the vapors. The specimens were allowed to sit at room temperature for 48-72 hours. The specimens were visually inspected and showed no indication of cracking, flaking, cloudiness, delamination, crazing or any visible signs of degradation. The initial haze of the specimens ranged from 0.9 to 1.4. The final haze ranged from 1.2 to 1.3; an insignificant change.

Finally, the temperature stability of the PECVD DLC+polysiloxane coated polycarbonate was tested by placing a Taber abrasion sample (100×100 mm square) through an autoclave cycle using 95 psi and up to 120 deg C. for 6 hours. This was followed by placement into a chamber pre-cooled to −31 deg C., where it soaked for 2 hours, and was then transferred in less than one minute to a pot of water pre-heated to +71 deg C. and soaked for 2 hours. The sample was towel and air dried for 30 minutes, then performed the Taber abrasion test described earlier. The change in haze after 100 cycles was 0.35, after 500 cycles was 1.05, and after 1000 cycles was 1.28. This indicated an ability to retain abrasion resistant properties over extreme temperature ranges and thermal shock.

The data presented in this section thus discloses a multi-layered transparent window that exhibits the following characteristics, among other favorable ones.
The abrasion resistance of the external strike face surface of window 20 is such that there is less than 2% change in haze when tested with 1000 cycles of CSF10 wheel, 500 gram load on each wheel in the Taber abrasion test according to ASTM D1044.
Window 20 includes a transparent plastic strike face that has a photopic transmission with respect to illuminate A (per ATPD 2352, rev R) greater than or equal to 85%. The night vision goggle compatibility as calculated using the algorithm provided in ATPD 2352 rev R is greater than or equal to 85%, and the haze per ASTM D1003 less than or equal to 1.4%.
Window 20 can be impacted with a 20 gram, 19-20 mm diameter, 30-31 mm long 2017 A grade Aluminum object with a 90 degree conical nose comprising 9-11 mm of the tip traveling at 140 m/s (314 mph) without creating any cracking or chipping to the glass, glass-ceramic, or transparent ceramic sublayers. Any scuffing or marring damage created in the plastic strike face does not grow when the window is taken down to −43 deg C.
Window 20 includes a plastic strike face that resists degradation to commercial diesel fuel, thirty weight motor oil, and household window cleaner such that after 48 hour exposure to the vapors or direct contact, the coated polymer shows no delamination, cracking, crazing or clouding and less than 1% change in haze per ASTM D1003.
Window 20 includes a plastic strike face that is capable of exposure to 120 deg C. for 6 hours and shows no delamination, cracking, crazing or clouding, and resists abrasion such that there is less than 2% change in haze when tested with 1000 cycles of CSF10 wheel, 500 gram load on each wheel in the Taber abrasion test according to ASTM D1044.
Window 20 includes a plastic strike face that is capable of exposure to thermal shock between −31 deg C. and +71 deg C. and shows no delamination, cracking, crazing or clouding, and resists abrasion such that there is less than 2% change in haze when tested with 1000 cycles of CSF10 wheel, 500 gram load on each wheel in the Taber abrasion test according to ASTM D1044
Window 20 exhibits the ability for the surface of the strike face to heat up to above freezing temperatures from −32 deg C. in less than 5 minutes when heated by a de-icing mat delivering 1800 W/square meter.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

1. A multi-layer transparent window, comprising:
a strike face, wherein said strike face comprises a transparent polymer layer and a layer selected from the group consisting of an organometallic layer, a coating layer, and a combination thereof, wherein said layer is adjacent to said transparent polymer layer;
an adhesive layer adjacent to said transparent polymer layer of said strike face; and
a bulk layer adjacent to said adhesive layer on an opposite side of said adhesive layer from said strike face, wherein said bulk layer comprises at least one layer of a material selected from the group consisting of glass, glass-ceramic, and transparent ceramic,
wherein said adhesive layer is chemically bonded to said transparent polymer layer at a first interface between said adhesive layer and said transparent polymer layer.

2. The window of claim 1, wherein said bulk layer is chemically bonded to said adhesive layer at a second interface between said bulk layer and said adhesive layer.

3. The window of claim 1, wherein said adhesive layer comprises a material selected from the group consisting of thermoplastic aliphatic polyurethane, polyvinyl butyral, ethylene/methacrylic acid copolymer, polyvinyl acetal resin, silicone, acrylonitrile-butadiene-styrene, acetal resin, cellulose acetate, cellulose acetate butyrate, cellulose acetate propionate, cellulose tri-acetate, acrylic, modified acrylic, allyl resin, chlorinated polyether, ethyl cellulose, epoxy, fluoroplastic, ionomer, melamine, nylon, parylene polymer, transparent phenolic, phenoxy resin, polybutylene, polycarbonate, polyester, polyethylene, polyphenylene, polypropylene, polystyrene, polyurethane, polysolphone, polyvinyl-acetate, polyvinyl butyral, silicone, styrene-acrylonitride, styrene-butadiene copolymer, and any combinations thereof.

4. The window of claim 1, wherein said transparent polymer layer comprises a material selected from the group consisting of polycarbonate, polymethyl methacrylate, poly (methyl 2-methylpropenoate), polyurethane, nylon, polyimide, polyamide, PET (polyethyleneterephthalate), polyester, and combinations thereof.

5. The window of claim 1, wherein said strike face comprises said transparent polymer layer, said organometallic layer, and said coating layer, wherein said organometallic layer is sandwiched between said transparent polymer layer and said coating layer.

6. The window of claim 5, wherein said transparent polymer layer comprises a material selected from the group consisting of polycarbonate, polymethyl methacrylate, poly (methyl 2-methylpropenoate), polyurethane, nylon, polyimide, polyamide, PET (polyethyleneterephthalate), polyester, and combinations thereof.

7. The window of claim 5, wherein said adhesive layer comprises a material selected from the group consisting of thermoplastic aliphatic polyurethane, polyvinyl butyral, ethylene/methacrylic acid copolymer, polyvinyl acetal resin, silicone, acrylonitrile-butadiene-styrene, acetal resin, cellulose acetate, cellulose acetate butyrate, cellulose acetate propionate, cellulose tri-acetate, acrylic, modified acrylic, allyl resin, chlorinated polyether, ethyl cellulose, epoxy, fluoroplastic, ionomer, melamine, nylon, parylene polymer, transparent phenolic, phenoxy resin, polybutylene, polycarbonate, polyester, polyethylene, polyphenylene, polypropylene, polystyrene, polyurethane, polysolphone, polyvinyl-acetate, polyvinyl butyral, silicone, styrene-acrylonitride, styrene-butadiene copolymer, and any combinations thereof.

8. The window of claim 5, wherein said coating layer comprises a material selected from the group consisting of silicon monoxide, silica, silicon nitride, silicon organometallic, diamond like carbon, and combinations thereof.

9. The window of claim 5, wherein at least one of said transparent polymer layer, said organometallic layer, and said coating layer comprises ultraviolet additives.

10. The window of claim 1, wherein said transparent polymer layer comprises polycarbonate and said adhesive layer comprises polyurethane.

11. The window of claim 10, further comprising a film of aliphatic polyurethane between said transparent polymer layer and said adhesive layer, to effect said chemical bond at said first interface.

12. The window of claim 1, wherein said adhesive layer comprises a de-icing component.

13. A process for preparing a multi-layer transparent window, comprising the steps of:
preparing a bi-laminate of a transparent polymer layer and an adhesive layer; and
creating a chemical bond at an interface between said transparent polymer layer and said adhesive layer.

14. The process of claim 13, wherein said creating step comprises illuminating said bi-laminate with light energy, to effect said chemical bond.

15. The process of claim 14, wherein said light energy comprises ultraviolet light energy.

16. The process of claim 13, wherein said illuminating step comprises illuminating said bi-laminate with sufficient power to induce an exothermic reaction at said interface, so that a temperature at said interface during said exothermic reaction is between one-hundred-fifty and three hundred degrees Celsius.

17. The process of claim 13, further comprising the step of, during said preparing step, applying a thin film of monomer between said transparent polymer layer and said adhesive layer.

18. The process of claim 17, further comprising the step of, during said preparing step, adding ground particles of said adhesive layer to said thin film of monomer.

19. The process of claim 13, further comprising the step of applying, to a side of said transparent polymer that is opposite to said interface, at least one of an organometallic layer and a coating layer.

20. The process of claim 13, further comprising the step of applying, to a side of said transparent polymer that is opposite to said interface, an organometallic layer and a coating layer.

21. The process of claim 17, wherein said coating layer is applied with a chemical vapor deposition process.

22. A multi-layer transparent window, comprising:
a strike face having a front surface and a rear surface, said strike face comprising:
a transparent polymer layer;
an organometallic layer adjacent to said transparent polymer layer; and
a coating layer to form said front surface of said strike face and adjacent to said organometallic layer, wherein said coating layer comprises a material selected from the group consisting of silicon monoxide, silica, silicon nitride, silicon organometallics, diamond like carbon, and combinations thereof; and
an adhesive layer chemically bonded to said transparent polymer layer at said rear surface of said strike face.

23. The multi-layer transparent window of claim 22,
wherein said transparent polymer layer comprises polycarbonate, and
wherein said adhesive layer comprises polyurethane.
